(19) United States
(12) Patent Application Publication
(10) Pub. No.: US 2021/0146658 A1
(43) Pub. Date: May 20, 2021

(54) MULTILAYER CABLES FOR AN OFFSHORE ENVIRONMENT

(71) Applicant: Arkema France, Colombes (FR)

(72) Inventors: Jerome CHAUVEAU, Mesnil En Ouche (FR); Jerome RONDIN, Courbepine (FR); Florent ABGRALL, Caorches-Saint-Nicolas (FR)

(21) Appl. No.: 17/055,299

(22) PCT Filed: May 14, 2019
(86) PCT No.: PCT/FR2019/051092

§ 371 Date: Jan. 6, 2021

(30) Foreign Application Priority Data
May 22, 2018 (FR) 1870583

(51) Int. Cl. B32B 15/085; B32B 1/08; B32B 15/20; B32B 27/08; B32B 27/30; B32B 27/32; B32B 27/26; B32B 7/12; H01B 3/44; H01B 7/28

(52) U.S. Cl. CPC B32B 15/085; B32B 2307/202; B32B 15/20; B32B 27/08; B32B 27/304; B32B 27/308; B32B 27/32; B32B 27/26; B32B 7/12; H01B 3/445; H01B 7/28; B32B 2270/00; B32B 2457/00; B32B 2597/00; B32B 2250/04; B32B 1/08

(57) ABSTRACT

The invention relates to the field of cables for an offshore environment (known as “downhole cables”). More particularly, the invention relates to an electrical cable having an insulating multilayer structure based on fluorinated polymers and polyolefins. This structure is made up of multiple layers that are intercohesive and obtained by coextrusion. The invention also relates to the use of said cable as a drilling material for extracting petroleum or natural gas.

### FIELD OF THE INVENTION

The present invention relates to the field of cables for an offshore environment (known as “downhole cables”). More particularly, the invention relates to an electrical cable comprising an insulating multilayer structure based on fluoropolymers and polyolefins. This structure is made up of several layers that are intercohesive and obtained by coextrusion. The invention also relates to the use of said cable as a drilling material for extracting petroleum or natural gas.

### TECHNICAL BACKGROUND

Cables known as “downhole cables” are cables which allow the power supply of drilling utilities in the context of the activity of petroleum or gas exploitation. These cables or these cable structures (made up of several individual cables) are used in the context of API 17J chemical specifications and in a thermal environment ranging from 130 to 180° C.

An electrical cable generally consists of a conductive material coated with one or more layers of polymeric materials acting as chemical and thermal insulator. During their use, electrical cables are commonly subjected to mechanical, chemical and thermal stresses, which are detrimental to the integrity of the insulation thereof.

According to the API 17J chemical specifications, electrical cables and cable structures are subject to operating conditions comprising at least the following elements:
brackish water (mixture of dirty water, petroleum, minerals and gas),
gas pressure ranging up to 18 MPa,
hydrostatic pressure ranging up to 35 MPa, exposure temperatures ranging from −40° C. to 180° C.,
pH ranging from 5.0 to 8.5, it being possible for this range to be extended from 3.0 to 9.5 and, for times of up to 6 hours, for it to go down to a pH equal to zero,
presence of aggressive chemical agents such as: H₂S (up to 1.25 g/1), CO₂ (up to 0.15 g/1), Cl (up to 20 g/1), HCO₃ (up to 1 g/1), Ca (up to 2 g/1), Mg (up to 0.13 g/1), Fe (up to 0.032 g/1), Na+K (up to 8.6 g/1).

The objective of these specifications is to prevent any swelling and/or shrinkage and/or cracking of the insulating layers which are in contact with the extraction medium having the characteristics described above. The insulating layers must in particular be subjected to pHs ranging from time to time down to 0 and concentrations of hydrochloric acid injected into the well of up to 30% by weight.

Electrical cables insulated with the aid of multilayer structures comprising an inner layer of polyethylene and an outer layer of a fluoropolymer (for example of polyvinylidene fluoride or PVDF) are known. However, the inner layer and the outer layer can delaminate easily due to the lack of adhesion between the two types of polymers, which have no chemical affinity for each other, resulting in weakening of the entire electrical cable. It is therefore desirable to be able to improve the adhesion between the layers in order to improve the properties of electrical cables.

The applicant has already proposed, in document WO 2007/006897, to solve this delamination problem by combining a layer based on a polyolefin and/or on a functionalized polyolefin and a fluoropolymer layer comprising at least one fluoropolymer onto which at least one unsaturated monomer has been grafted by irradiation. This multilayer structure gives very satisfactory results in terms of adhesion between layers; however, the fluoropolymer modified by irradiation grafting, used in this structure, alone or as a mixture, has a low grafting rate which can limit the adhesion and the maintaining thereof over time in severe environments as described above.

There is therefore a need to develop new insulating multilayer structures for electrical cables used for extracting petroleum or natural gas, which have sufficient chemical and thermal resistance over the entire period of use of these cables for periods that can be up to 20 years, while maintaining their functional and structural integrity by virtue of improved adhesion between the polyolefin-based layer(s) and the fluoropolymer-based layer.

### SUMMARY OF THE INVENTION

The invention relates firstly to an electrical cable comprising a conductive core surrounded by a multilayer structure intended to protect said core from chemical and thermal attacks. This multilayer structure is obtained by coextrusion and then crosslinked by electron-beam irradiation.

Various multilayer structures are targeted by the invention; they include the following layers, from the inside to the outside:
a first internal layer c1 predominantly of polyolefin, acting as an insulating layer;
optionally, a layer c1′ acting as a binder consisting of a polyolefin different than that of the layer c2 and having reactive functions obtained by copolymerization or grafting;
a second layer c2 acting as a binder, chemically compatible with the polyolefinic internal layer and having reactive functions obtained by copolymerization or grafting;
a third layer c3 comprising a second binder capable of reacting chemically with the second layer c2. This layer is fluorinated and already provides resistance to external chemical attacks;
a protective fourth layer c4 comprising a fluoropolymer based on vinylidene fluoride making it possible to provide chemical and thermal resistance.

Each of the layers described above can, independently, include a crosslinking agent. According to one embodiment, the layers c1 and c4 each contain a crosslinking agent, the weight content of which varies, independently from one layer to another, from 0.5 to 5%, preferentially between 2 and 4%.

According to one embodiment, the layers c2 and/or c3 do not contain crosslinking agent.

According to another embodiment, the layers c2 and/or c3 contain a crosslinking agent at a rate ranging from 0.5 to 5%, preferentially between 2 and 4%.

The multilayer structures are obtained by coextrusion, then crosslinked by irradiation.

The invention also relates to cable structures made up of several individual cables having the structure described above, wrapped in a protective layer.

The invention also relates to a process for manufacturing the multilayer structure by coextrusion followed by crosslinking by irradiation.

The invention also relates to the use of such an electrical cable as drilling material for extracting petroleum or natural gas or for geothermal drilling.

Advantageously, the use of an electrical cable comprising this structure, in the petroleum or natural gas drilling environment, makes it possible to avoid severe damage to the electrical insulation layers of each cable making up the cable structure, which would cause a complete malfunction of the line.

The present invention makes it possible to overcome the drawbacks of the prior art. It more particularly provides a cable exhibiting a combination of properties, namely:
better adhesion to the interfaces of the layers enveloping the metal core of the cable by virtue of the use of coextrusion binders (c2 and c3),
improved thermal resistance due to the crosslinking of all the layers, for temperatures ranging up to 180° C.,
improved dimensional stability under temperature due to the crosslinking of all the layers,
better barrier properties against oils and solvents thanks to the use of a fluorinated external protective layer (see above),
better resistance to abrasion, through the crosslinking of the external layer in contact with the other cables and of the internal layer in contact with the core of the cable.

The improvements described above relate to cables known to those skilled in the art, in particular:
cables comprising only an insulating layer of crosslinked polyolefin, and
cables comprising an insulating layer of polyolefin and a fluorinated barrier layer, all crosslinked.

### DESCRIPTION OF EMBODIMENTS OF THE INVENTION

The invention is now described in greater detail and in a nonlimiting manner in the description which follows.

The invention proposes to provide an electrical cable capable of withstanding an offshore environment. To this end, it relates, according to a first aspect, to a cable comprising a conductive core surrounded by a multilayer structure intended to protect said core from chemical and thermal attacks.

The various constituent parts of the cable according to the invention are described below.

According to various embodiments, said cable comprises the following features, combined where appropriate.

Conductive Core

The core of the cable is a current-conducting material chosen from copper, copper-nickel alloys, aluminum and composite electrical materials.

Multilayer Structure

Various multilayer structures are targeted by the invention; they include the following layers, from the inside to the outside:
a first internal layer c1 predominantly of polyolefin, acting as an insulating layer;
optionally, a layer c1′ acting as a binder consisting of a polyolefin different than that of the layer c2 and having reactive functions obtained by copolymerization or grafting;
a second layer c2 acting as a binder, chemically compatible with the polyolefinic internal layer (c1 or c1′), consisting of a polyolefin and having reactive functions obtained by copolymerization or grafting;
a third layer c3 acting as a binder and based on a mixture of fluoropolymer and functionalized acrylic polymer, which can react chemically with the second layer c2; and
a protective fourth layer c4 comprising a fluoropolymer based on vinylidene fluoride making it possible to provide chemical and thermal resistance.

Internal Layer c1

The insulating layer is mainly composed of polyolefin. This term denotes a polymer mainly comprising ethylene and/or propylene units.

According to one embodiment, the polyolefin is a polyethylene (PE), homo- or copolymer, the comonomer being chosen from propylene, butene, hexene or octene. It can also be a polypropylene (PP), homo- or copolymer, the comonomer being chosen from ethylene, butene, hexene or octene. The polypropylene is an iso- or syndiotactic polypropylene.

According to one embodiment, the polyethylene is chosen from high density polyethylene (HDPE), low density polyethylene (LDPE), medium density polyethylene (MDPE), linear low density polyethylene (LLDPE) and very low density polyethylene (VLDPE). The polyethylene may be obtained using a Ziegler-Natta, Phillips or metallocene-type catalyst or else using the high-pressure process.

According to one embodiment, the polyolefin is a copolymer of ethylene and propylene (known as EPM) or a copolymer of ethylene, propylene and a diene (such as 1,4-hexadiene, ethylidene norbornene or butadiene), known as EPDM.

According to one embodiment, said copolymer of ethylene and propylene is a block copolymer.

According to one embodiment, the polyolefin constituting the layer c1 is a crosslinked polyethylene (abbreviated to PEX). Compared to uncrosslinked PE, PEX has better mechanical properties (in particular resistance to cracking) and better chemical resistance. The crosslinked polyethylene can be, for example, a polyethylene comprising hydrolyzable silane groups (as described in documents WO 01/53367 or US 20040127641) which has subsequently been crosslinked after reacting the silane groups with each other. The reaction of the Si—OR silane groups with each other leads to Si—O—Si bonds which connect the polyethylene chains to each other. The content of hydrolyzable silane groups can be at least 0.1 hydrolyzable silane groups per 100 —CH₂— units (determined by infrared spectrometry).

According to one embodiment, the polyethylene is crosslinked by means of radiation, for example gamma radiation. It may also be a polyethylene crosslinked by means of a radical initiator of the peroxide type. A PEX of type A (crosslinking using a radical initiator), type B (crosslinking using silane groups) or type C (crosslinking by irradiation) may therefore be used.

Layers Acting as a Binder

The multilayer structure surrounding the conductive core of the cable according to the invention comprises two or three layers acting as a binder between the insulating layer c1 and the protective layer c4.

Layer c1′—Optional Binder Layer

According to one embodiment, the multilayer structure which surrounds the conductive core of the cable according to the invention comprises a binder layer based on a functionalized polyolefin, denoted c1′. This is particularly the case when the layer c1 is made of polypropylene. This layer is placed between the layer c1 and the layer c2.

The layer c1′ comprises a functionalized olefinic polymer having a structure different than that of the functionalized polyolefin constituting the layer c2. This ensures better cohesion between these binder layers, the functional groups of the polyolefin of the layer c1′ being able to interact with the functional groups of the polyolefin constituting the layer c2.

The functional groups of the functionalized polyolefin of the layer c1′ are chosen from unsaturated carboxylic acids, unsaturated dicarboxylic acids having 4 to 10 carbon atoms, and anhydride derivatives thereof.

The functionalized polyolefin is chosen from polymers obtained by grafting at least one unsaturated polar monomer having a functional group as described above onto at least one propylene homopolymer or a copolymer of propylene and of an unsaturated polar monomer chosen from C₁-C₈ alkyl esters or glycidyl esters of unsaturated carboxylic acids, or salts of unsaturated carboxylic acids, or a mixture thereof. Preferably, the functionalized polyolefin of the layer c1′ is a polypropylene grafted with maleic anhydride.

Advantageously, the polymer comprises, by weight, an amount of said grafting monomer of less than or equal to 5%.

Layer c2

The binder layer c2 is chemically compatible with the insulating internal layer c1 or with the layer c1′, if it is present. It consists of a functionalized polyolefin which has reactive functions obtained by copolymerization or grafting.

According to one embodiment, the functionalized polyolefin is a copolymer of ethylene and/or propylene and at least one unsaturated polar monomer chosen from:
C₁-C₈ alkyl (meth)acrylates, in particular methyl, ethyl, propyl, butyl, 2-ethylhexyl, isobutyl or cyclohexyl (meth)acrylate;
unsaturated carboxylic acids, salts thereof and anhydrides thereof, in particular acrylic acid, methacrylic acid, maleic anhydride, itaconic anhydride, citraconic anhydride;
unsaturated epoxides, in particular aliphatic glycidyl esters and ethers, such as allyl glycidyl ether, vinyl glycidyl ether, glycidyl maleate and itaconate, glycidyl methacrylate and acrylate, and also alicyclic glycidyl esters and ethers;
vinyl esters of saturated carboxylic acids, in particular vinyl acetate, vinyl propionate or vinyl butyrate.

The functionalized polyolefin can be obtained by copolymerization of ethylene and/or propylene and at least one unsaturated polar monomer chosen from the above list. The copolymerization is carried out at high pressures greater than 1000 bar according to the “high-pressure” process, described for example in documents FR 2498609, EP 0 174 244 or EP 0 177 378.

According to one embodiment, the functionalized polyolefin obtained by copolymerization comprises by weight from 50 to 99.9% of ethylene, preferably from 60 to 99.9%, even more preferentially from 65 to 99%, and from 0.1 to 50%, preferably from 0.1 to 40%, even more preferentially from 1 to 35% of at least one polar monomer from the above list.

According to one embodiment, the functionalized polyolefin is a copolymer of ethylene and of an unsaturated epoxide, preferably glycidyl (meth)acrylate, and optionally of a C₁-C₈ alkyl (meth)acrylate or a vinyl ester of a saturated carboxylic acid. The content of unsaturated epoxide, in particular of glycidyl (meth)acrylate, is between 0.1 and 50%, advantageously between 0.1 and 40%, preferably between 1 and 35%, even more preferentially between 1 and 20%.

According to one embodiment, the functionalized polyolefin is a copolymer of ethylene and of an unsaturated acid anhydride, preferably maleic anhydride, and optionally of a C₁-C₈ alkyl (meth)acrylate or a vinyl ester of a saturated carboxylic acid. The content of unsaturated acid anhydride, in particular of maleic anhydride, is between 0.1 and 50%, advantageously between 0.1 and 40%, preferably between 1 and 35%, even more preferentially between 1 and 10%.

According to one embodiment, the functionalized polyolefin forming the layer c2 is obtained by radical grafting of an unsaturated polar monomer such as those mentioned above, onto a polyolefin. The grafting takes place in an extruder or in solution in the presence of a radical initiator. As an example of radical initiators, use may be made of t-butyl hydroperoxide, cumene hydroperoxide, diisopropylbenzene hydroperoxide, di-(t-butyl) peroxide, (t-butyl)cumyl peroxide, dicumyl peroxide, 1,3-bis((t-butyl)peroxyisopropyl)benzene, benzoyl peroxide, isobutyryl peroxide, bis-3,5,5-trimethylhexanoylperoxide or methyl ethyl ketone peroxide.

The grafting of an unsaturated polar monomer onto a polyolefin is known to those skilled in the art; for more details, reference may be made, for example, to documents EP 0 689 505 or U.S. Pat. No. 5,235,149. The polyolefin onto which the unsaturated polar monomer is grafted can be a polyethylene, in particular high density polyethylene (HDPE) or low density polyethylene (LDPE), linear low density polyethylene (LLDPE), very low density polyethylene (VLDPE). The polyethylene may be obtained using a Ziegler-Natta, Phillips or metallocene-type catalyst or else using the high-pressure process. The polyolefin can also be a polypropylene, in particular an iso- or syndiotactic polypropylene.

According to one embodiment, the polymer onto which the unsaturated polar monomer is grafted is a copolymer of ethylene and of at least one unsaturated polar monomer chosen from:
C₁-C₈ alkyl (meth)acrylates, in particular methyl, ethyl, propyl, butyl, 2-ethylhexyl, isobutyl or cyclohexyl (meth)acrylate;
vinyl esters of saturated carboxylic acids, especially vinyl acetate or vinyl propionate.

The layer c2 can comprise a single functionalized polyolefin or a mixture of several functionalized polyolefins, optionally mixed with a non-functionalized polyolefin. It may for example be a mixture:
of a copolymer of ethylene and of a C₁-C₈ alkyl (meth)acrylate or of a vinyl ester of a saturated carboxylic acid,
with a copolymer of ethylene and of an unsaturated epoxide, preferably glycidyl (meth)acrylate, and optionally of a C₁-C₈ alkyl (meth)acrylate or of a vinyl ester of a saturated carboxylic acid.

Another example of a mixture is that:
of a copolymer of ethylene and of a C₁-C₈ alkyl (meth)acrylate or of a vinyl ester of a saturated carboxylic acid
with a copolymer of ethylene and of an unsaturated acid anhydride, preferably maleic anhydride, and optionally of a C₁-C₈ alkyl (meth)acrylate or of a vinyl ester of a saturated carboxylic acid.

According to one preferred embodiment, the layer c2 is made up of a copolymer of ethylene and of glycidyl methacrylate.

Fluorinated Binder Layer c3

This binder layer comprises a mixture of at least one fluoropolymer and a functionalized acrylic copolymer. It is able to react chemically with the layer c2, increasing the cohesion of the multilayer structure. This layer is fluorinated and thus contributes to the resistance to external chemical attacks of the cable.

The fluoropolymer of the layer c3 is chosen from homopolymers of vinylidene fluoride (PVDF) and copolymers of vinylidene fluoride and of at least one other comonomer. According to one embodiment, the comonomer of the VDF is chosen from vinyl fluoride, trifluoroethylene (VF3), chlorotrifluoroethylene (CTFE), 1,2-difluoroethylene, tetrafluoroethylene (TFE), hexafluoropropylene (HFP), perfluoro (alkyl vinyl) ethers such as perfluoro (methylvinyl) ether (PMVE), perfluoro (ethylvinyl) ether (PEVE), perfluoro (propylvinyl) ether (PPVE), perfluoro (1,3-dioxozole); perfluoro (2,2-dimethyl-1,3-dioxole) (PDD), the product of formula CF₂═CFOCF₂CF(CF₃)OCF₂CF₂X wherein X is SO₂F, CO₂H, CH₂OH; CH₂OCN or CH₂OPO₃H, the product of formula CF₂═CFOCF₂CF₂SO₂F; the product of formula F(CF₂)ₙCH₂OCF═CF₂ wherein n is 1, 2, 3, 4 or 5, the product of formula R₁CH₂OCF═CF₂ wherein R₁ is hydrogen or F(CF₂)_{z} and z is 1, 2, 3, or 4; the product of formula R₃OCF═CH₂ wherein R₃ is F(CF₂)_{z} and z is 1, 2, 3, or 4 or else perfluorobutylethylene (PFBE), fluoroethylenepropylene (PEP), 3,3,3-trifluoropropene, 2-(trifluoromethyl)-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3-tetrafluoropropene or HFO-1234ye, 1,1,3,3-tetrafluoropropene or HFO-1234zc, chlorotetrafluoropropene or HCFO-1224, chlorotrifluoropropenes (in particular 2-chloro-3,3,3-trifluoropropene), 1-chloro-2-fluoroethylene, trifluoropropenes (in particular 3,3,3-trifluoropropene), pentafluoropropenes (in particular 1,1,3,3,3-pentafluoropropene or 1,2,3,3,3-pentafluoropropene), 1-chloro-2,2-difluoroethylene, 1-bromo-2,2-difluoroethylene, and bromotrifluoroethylene. The copolymer may also comprise non-fluorinated monomers such as ethylene.

According to one embodiment, the fluorinated copolymer that can be used for the layer c3 is a copolymer of VDF and HFP.

According to one embodiment, the amount of HFP in this VDF-HFP copolymer is greater than 15% by weight and it has a melting point greater than 165° C.

The functionalized acrylic copolymer contained in layer c3 denotes a copolymer comprising:
units of the type:

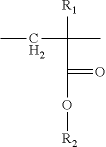

wherein R₁ and R₂ represent a hydrogen atom or a linear or branched alkyl having from 1 to 20 carbon atoms; it being possible for R₁ and R₂ to be identical or different;
and units of the type:

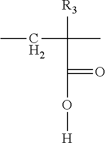

wherein R₃ is a hydrogen atom or a linear or branched alkyl containing one to twenty carbon atoms.

The latter unit may be in its acid form, but also in the form of its anhydride derivatives, or a mixture thereof. When it is in anhydride form, this unit may be represented by the formula:

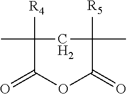

wherein R₄ and R₅ represent a hydrogen atom or a linear or branched alkyl having from 1 to 20 carbon atoms; it being possible for R₄ and R₅ to be identical or different.

According to one embodiment, the acrylic copolymer comprises up to 50% by weight of the unit in acid form or its anhydride derivative or a mixture of the two. Advantageously, the acrylic copolymer comprises up to 25% by weight of the unit in acid form or its anhydride derivative, or a mixture thereof.

According to another embodiment, R₁ and R₂ represent the methyl radical.

According to another embodiment, R₃ represents the hydrogen or methyl radical in the case where the unit that bears it is in acid form, and R₄ and R₅ represent the hydrogen or methyl radical in the case where the unit is in anhydride form.

According to one embodiment, the acrylic copolymer is a copolymer of methyl methacrylate and glutaric anhydride.

According to one embodiment, the acrylic copolymer is a copolymer of methyl methacrylate and of methacrylic acid.

According to one embodiment, the functionalized acrylic copolymer is a mixture of these two copolymers.

Advantageously, the acrylic copolymer of said layer c3 comprises, by weight, from 1% to 50%, preferably between 1% and 25%, limits included, of functionalized monomers.

Protective Layer c4

The multilayer structure surrounding the core of the cable comprises a fourth layer c4, the role of which is to provide further chemical and thermal resistance necessary for the use of the cable in the drilling environment.

This layer is made up of a fluoropolymer as described above for the layer c3.

According to one embodiment, said fluoropolymer is a vinylidene fluoride homopolymer.

According to one embodiment, said fluoropolymer is a VDF-HFP copolymer.

The fluoropolymers which are part of the composition of the layers c3 and c4 may be identical or different in the two layers. The layers may also comprise a mixture of at least two fluoropolymers, this mixture being identical or different in the layers c3 and c4.

According to one embodiment, the cable according to the invention consists of a conductive core surrounded by a coextruded and crosslinked multilayer structure consisting of 4 layers: layer c1, layer c2, layer c3 and layer c4 as described above.

According to one embodiment, the cable according to the invention consists of a conductive core surrounded by a coextruded and crosslinked multilayer structure consisting of 5 layers: layer c1, layer c1′, layer c2, layer c3 and layer c4 as described above.

Each of the layers described above, and independently, can comprise a crosslinking agent, preferentially triallyl isocyanurate (TAIL). Other examples of crosslinking agents: triallyl cyanurate (TAC), trimethylolpropane triacrylate (TMPTA), trimethylolpropane trimethacrylate (TMPTMA).

Other additives can be added in one of the layers or in several layers, namely zinc oxide (ZnO) and/or heat stabilizers of the phosphite type.

The multilayer structures described above are obtained by coextrusion, then crosslinked by irradiation. Among the most commonly used radiations are UV rays, infrared rays, X rays and electron beams (e-beam). Preferentially, electron beams are used by virtue of their excellent penetrating power, their high achievable dose and their industrial availability. Preferably, the irradiation dose used for the crosslinking of these structures is 100 kGy.

The multilayer structures described above have an external diameter ranging from 8 to 14 mm and a total thickness ranging from 2 to 3 mm Another subject of the invention consists of the use of an electrical cable having one of the abovementioned structures as drilling material for extracting petroleum or natural gas or for geothermal drilling.

Advantageously, these are cable structures made up of several individual cables having the structure described above, wrapped in a protective layer, which are used because of their greater resistance, in particular mechanical strength.

According to one embodiment, the cable structure consists of three individual cables according to the invention, each containing a copper wire, these copper wires being assembled in parallel.

The three cables are then covered and held together:
either by a polymer sheathing (PE, PP or PVDF),
or by a sheathing of glassfiber fabric or of rolled polyolefin fiber fabric (“wrapping”).

The three cables and the sheathing are then covered:
either by a PET or polyolefin film, and a nonwoven dry laid made of rolled polyolefin or PET,
or by a dry laid nonwoven made of PET or of rolled polyolefin,
   the whole being protected by a flexible metallic weave.

### EXAMPLES

The examples that follow illustrate the invention without limiting it.

### Structure 1 (4 Layers)

insulation layer c1: HDPE, thickness 2.1 mm
binder layer c2: copolymer of ethylene and glycidyl methacrylate, thickness 0.1 mm
binder layer c3: mixture of fluorinated VDF-HFP copolymer and copolymer of methyl methacrylate and glutaric anhydride, thickness 0.1 mm
protective layer c4: VDF-HFP copolymer, thickness 0.4 mm

### Structure 2 (4 Layers)

insulation layer c1: HDPE, thickness 2.1 mm
binder layer c2: copolymer of ethylene and glycidyl methacrylate, thickness 0.1 mm
binder layer c3: mixture of fluorinated VDF-HFP copolymer and copolymer of methyl methacrylate and glutaric anhydride, thickness 0.1 mm
protective layer c4: VDF-HFP copolymer, thickness 0.4 mm

The multilayer structure obtained by coextrusion is irradiated by electron beam (dose: 100 kGy)

### Structure 3 (4 Layers)

insulation layer c1: HDPE+3% TAIC, thickness 2.1 mm
binder layer c2: copolymer of ethylene and glycidyl methacrylate, thickness 0.1 mm
binder layer c3: mixture of fluorinated VDF-HFP copolymer and copolymer of methyl methacrylate and glutaric anhydride, thickness 0.1 mm
protective layer c4: VDF-HFP copolymer+3% TAIC, thickness 0.4 mm

The multilayer structure obtained by coextrusion is irradiated by electron beam (dose: 100 kGy)

### Structure 4 (1 Layer): Counterexample

Single-layer structure made of HDPE+3% TAIC (total thickness=2.7 mm) irradiated by electron beam (dose: 100 kGy).

### Structure 5 (5 Layers)

insulation layer c1: PP copolymer, thickness 2.1 mm
binder layer c1′: polypropylene grafted with maleic anhydride, thickness 0.1 mm
binder layer c2: copolymer of ethylene and glycidyl methacrylate, thickness 0.1 mm
binder layer c3: mixture of fluorinated VDF-HFP copolymer and copolymer of methyl methacrylate and glutaric anhydride, thickness 0.1 mm
protective layer c4: VDF-HFP copolymer, thickness 0.4 mm.

Table 1 shows the advantage of using the multilayer structures 1, 2 and 3 in the field of cables allowing the power supply of drilling utilities for petroleum or gas exploitation. The structure 3 makes it possible in particular to significantly increase the temperature at which the cable can be used.

The term “Pass” means that, despite exposure to the indicated temperature in petroleum and brackish water, the structure retains its physical integrity and sufficient mechanical properties, thereby allowing long-term electrical insulation of the cable.

The term “Fail” means that the cable, having been subjected to the exposure to the temperature indicated in petroleum and brackish water, experiences a significant loss of its mechanical properties and its physical integrity, thereby leading to a short circuit during the current flow, and therefore to the loss of electrical insulation of the cable.

### Measurement of the Adhesion:

The interlayer adhesion is measured by a peel test according to the “imposed 90° peel” method at a temperature of 23° C. and a pull rate of 50 mm/min Strips approximately 7 mm wide are cut from the tubes. These strips were primed using tweezers and a cutter. Once primed, one of the strips is placed in an assembly suitable for small-diameter tubes.

The lever arm consists of the layers c4 and c3 and has a total thickness of 500 μm. The interface subjected to stress is thus the one between the layers c3 and c2. The adhesion measurement is carried out 24 h after the multilayer structure has been produced. Adhesion measurements following the same protocol are also carried out after the multilayer structure has been crosslinked by electron-beam irradiation.

### Temperature Aging:

The cables considered are immersed in petroleum and brackish water for 1200 h in an oven set to the desired temperature (130, 150 or 170° C.). After exposure to the indicated temperature, the integrity of the cable is characterized by visual examination and an electrical continuity measurement is carried out using a multimeter.

TABLE 1

| | | Adhesion at | Adhesion | | | |
|---|---|---|---|---|---|---|
| | | t0 (N/cm) | after | Temperature aging for 1200 h in a mixture of | | |
| | | at C2//C3 | crosslinking | petroleum & brackish water | | |
| | Crosslinking | interface | (N/cm) | 130° C. | 150° C. | 170° C. |
| Structure 1 | No | 62 | — | Pass | Fail | — |
| Structure 2 | Yes | 58 | 55 | Pass | Fail | — |
| Structure 3 | Yes | 40 | 52 | Pass | Pass | Pass |
| Structure 4 | Yes | — | — | Fail | — | — |

1. An electrical cable comprising a conductive core surrounded by a coextruded and reticulated multilayer structure comprising, from the inside to the outside:
an internal layer c1 of polyolefin;
optionally, a binder layer c1′ based on a functionalized polyolefin;
a binder layer c2, chemically compatible with the layer c1 or the layer c1′ and having reactive functions obtained by copolymerization or grafting;
a binder layer c3 comprising a mixture of at least one fluoropolymer and a functionalized acrylic copolymer;
a protective layer c4 comprising a fluoropolymer based on vinylidene fluoride.

2. The cable as claimed in claim 1, wherein said core is a current-conducting material chosen from copper, copper-nickel alloys, aluminum and composite electrical materials.

3. The cable as claimed in either of claims 1 and 2, wherein said layer c1 consists of a polyolefin chosen from:
polyethylene homopolymer chosen from high density polyethylene (HDPE), low density polyethylene (LDPE), medium density polyethylene (MDPE), linear low density polyethylene (LLDPE) and very low density polyethylene (VLDPE);
copolymers of ethylene and of a comonomer chosen from propylene, butene, hexene or octene;
polypropylene homo- or copolymer, the comonomer being chosen from ethylene, butene, hexene or octene;
copolymers of ethylene and propylene, including block copolymers, or copolymers of ethylene, propylene and a diene such as 1,4-hexadiene, ethylidene norbornene or butadiene;
crosslinked polyethylene chosen from a polyethylene comprising hydrolyzable silane groups which has subsequently been crosslinked after reacting silane groups with each other, and polyethylene crosslinked by means of radiation.

4. The cable as claimed in one of claims 1 to 3, wherein said layer c2 consists of a functionalized polyolefin which has reactive functions obtained by copolymerization or grafting.

5. The cable as claimed in claim 4, wherein said functionalized polyolefin is a copolymer of ethylene and/or propylene and of at least one unsaturated polar monomer chosen from:
C₁-C₈ alkyl (meth)acrylates, in particular methyl, ethyl, propyl, butyl, 2-ethylhexyl, isobutyl or cyclohexyl (meth)acrylate;
unsaturated carboxylic acids, salts thereof and anhydrides thereof, in particular acrylic acid, methacrylic acid, maleic anhydride, itaconic anhydride, citraconic anhydride;
unsaturated epoxides, in particular aliphatic glycidyl esters and ethers, such as allyl glycidyl ether, vinyl glycidyl ether, glycidyl maleate and itaconate, glycidyl methacrylate and acrylate, and also alicyclic glycidyl esters and ethers;
vinyl esters of saturated carboxylic acids, in particular vinyl acetate, vinyl propionate or vinyl butyrate.

6. The cable as claimed in claim 4, wherein said functionalized polyolefin is a copolymer of ethylene and of an unsaturated epoxide, preferably glycidyl (meth)acrylate, and optionally of a C₁-C₈ alkyl (meth)acrylate or a vinyl ester of a saturated carboxylic acid.

7. The cable as claimed in claim 4, wherein said functionalized polyolefin is a copolymer of ethylene and of an unsaturated acid anhydride, preferably maleic anhydride, and optionally of a C₁-C₈ alkyl (meth)acrylate or a vinyl ester of a saturated carboxylic acid.

8. The cable as claimed in claim 4, wherein said functionalized polyolefin is obtained by radical grafting of an unsaturated polar monomer onto a polyolefin.

9. The cable as claimed in one of claims 1 to 8, wherein said layer c1′ consists of at least one functionalized polyolefin obtained by grafting at least one unsaturated polar monomer having as functional group an unsaturated carboxylic acid, an unsaturated dicarboxylic acid having 4 to 10 carbon atoms, and the anhydride derivatives thereof, onto a propylene homopolymer or a copolymer of propylene and of an unsaturated polar monomer chosen from C₁-C₈ alkyl esters or glycidyl esters of unsaturated carboxylic acids, or salts of unsaturated carboxylic acids, or a mixture thereof.

10. The cable as claimed in one of claims 1 to 9, wherein said layer c3 comprises a mixture of at least one fluoropolymer and one functionalized acrylic copolymer.

11. The cable as claimed in claim 10, wherein said fluoropolymer is chosen from vinylidene fluoride homopolymers (PVDF) and copolymers of vinylidene fluoride and of at least one other comonomer, the latter being chosen from vinyl fluoride, trifluoroethylene (VF3), chlorotrifluoroethylene (CTFE), 1,2-difluoroethylene, tetrafluoroethylene (TFE), hexafluoropropylene (HFP), perfluoro (alkyl vinyl) ethers such as perfluoro (methylvinyl) ether (PMVE), perfluoro (ethylvinyl) ether (PEVE), perfluoro (propylvinyl) ether (PPVE), perfluoro (1,3-dioxozole); perfluoro (2,2-dimethyl-1,3-dioxole) (PDD), the product of formula CF₂═CFOCF₂CF(CF₃)OCF₂CF₂X wherein X is SO₂F, CO₂H, CH₂OH; CH₂OCN or CH₂OPO₃H, the product of formula CF₂═CFOCF₂CF₂SO₂F; the product of formula F(CF₂)ₙCH₂OCF═CF₂ wherein n is 1, 2, 3, 4 or 5, the product of formula R₁CH₂OCF═CF₂ wherein R₁ is hydrogen or F(CF₂)_{z} and z is 1, 2, 3, or 4; the product of formula R₃OCF═CH₂ wherein R₃ is F(CF₂)_{z} and z is 1, 2, 3, or 4 or else perfluorobutylethylene (PFBE), fluoroethylenepropylene (FEP), 3,3,3-trifluoropropene, 2-(trifluoromethyl)-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3-tetrafluoropropene or HFO-1234ye, 1,1,3,3-tetrafluoropropene or HFO-1234zc, chlorotetrafluoropropene or HCFO-1224, chlorotrifluoropropenes (in particular 2-chloro-3,3,3-trifluoropropene), 1-chloro-2-fluoroethylene, trifluoropropenes (in particular 3,3,3-trifluoropropene), pentafluoropropenes (in particular 1,1,3,3,3-pentafluoropropene or 1,2,3,3,3-pentafluoropropene), 1-chloro-2,2-difluoroethylene, 1-bromo-2,2-difluoroethylene, and bromotrifluoroethylene.

12. The cable as claimed in either of claims 10 and 11, wherein said fluoropolymer is a copolymer of vinylidene fluoride and hexafluoropropylene.

13. The cable as claimed in one of claims 10 to 12, wherein said acrylic copolymer is a copolymer of methyl methacrylate and glutaric anhydride, or a copolymer of methyl methacrylate and methacrylic acid, or a mixture of these two copolymers.

14. The cable as claimed in one of claims 1 to 13, wherein said layer c4 is a vinylidene fluoride homopolymer or a copolymer of vinylidene fluoride and hexafluoropropylene.

15. The cable as claimed in one of the preceding claims, wherein the layers c1 and c4 each contain from 0.5 to 5% by weight of a crosslinking agent.

16. The use of an electrical cable as claimed in one of claims 1 to 15 as a drilling material for extracting petroleum or natural gas or for geothermal drilling.

17. A process for manufacturing an electrical cable as claimed in one of claims 1 to 15 comprising a conductive core surrounded by a multilayer structure, wherein said multilayer structure is obtained by coextrusion, then crosslinked by electron-beam irradiation.
